(19) United States
(12) Patent Application Publication
(10) Pub. No.: US 2025/0095920 A1
(43) Pub. Date: Mar. 20, 2025

(54) ELECTRONIC COMPONENT

(71) Applicant: TDK Corporation, Tokyo (JP)

(72) Inventors: Yugo KANAMOTO, Tokyo (JP); Kyohei TAKATA, Tokyo (JP); Ken MORITA, Tokyo (JP); Atsushi TAKEDA, Tokyo (JP); Daisuke HIROTA, Tokyo (JP)

(73) Assignee: TDK Corporation, Tokyo (JP)

(21) Appl. No.: 18/797,801

(22) Filed: Aug. 8, 2024

(30) Foreign Application Priority Data
Sep. 15, 2023 (JP) 2023-150312

(51) Int. Cl. H01G 4/232; H01G 4/248

(52) U.S. Cl. CPC H01G 4/2325; H01G 4/248

(57) ABSTRACT

An electronic component includes an element body including a side surface and an external electrode disposed on the side surface. The external electrode includes a conductive resin layer. The conductive resin layer is formed with a ridge extending along at least one direction on the side surface. The conductive resin layer includes a region, on the side surface, having a thickness smaller than a thickness at the ridge.

### CROSS-REFERENCE TO RELATED APPLICATIONS

This application is based upon and claims the benefit of priority from Japanese Patent Application No. 2023-150312, filed on Sep. 15, 2023, the entire contents of which are incorporated herein by reference.

### BACKGROUND

### Field

The present disclosure relates to an electronic component.

### Description of the Related Art

Known electronic components include an element body and an external electrode on a side surface of the element body (for example, refer to Japanese Unexamined Patent Publication No. H5-144665). The external electrode includes a conductive resin layer.

### SUMMARY

The conductive resin layer includes, for example, a resin and electrically conductive particles. The resin tends to absorb moisture. When the electronic component is solder-mounted on an electronic device, the moisture absorbed by the resin may be gasified so that volume expansion may occur. In this case, stress may act on the conductive resin layer, and the conductive resin layer may peel off. The electronic device includes, for example, a circuit board or an electronic component.

One aspect of the present disclosure provides an electronic component capable of preventing peel-off of a conductive resin layer.

An electronic component according to one aspect of the present disclosure includes an element body including a side surface and an external electrode disposed on the side surface and including a conductive resin layer. The conductive resin layer is formed with a ridge extending along at least one direction, on the side surface. The conductive resin layer includes a region, on the side surface, having a thickness smaller than a thickness at the ridge.

The conductive resin layer tends to include open cell foam extending to an end edge of the conductive resin layer, for example, during forming the conductive resin layer. The open cell foam can include movement paths of a gas generated from moisture. The gas that has reached the end edge of the conductive resin layer can be emitted outside the external electrode. A configuration with a thicker conductive resin layer increases, for example, the number of the movement paths of the gas, as compared with a configuration with a thinner conductive resin layer.

In the one aspect described above, the conductive resin layer positioned on the side surface is formed with the ridge. A thickness of the conductive resin layer tends to increase in thickness at a region where the ridge is positioned. Therefore, the conductive resin layer increases the number of the movement paths of the gas at the region where the ridge is positioned.

The ridge is formed along the at least one direction, on the side surface. Therefore, even when moisture absorbed by the resin is gasified in the conductive resin layer positioned on the side surface, a gas generated from the moisture tends to move in the at least one direction within the region where the ridge is positioned. The gas moving through the region, of the conductive resin layer, where the ridge is positioned tends to move towards a position corresponding to an end edge of the side surface. In the conductive resin layer, the position corresponding to the end edge of the side surface is closer to the end edge of the conductive resin layer than a position corresponding to a center of the side surface. The one aspect described above tends to move the gas generated from the moisture to a position close to the end edge of the conductive resin layer. Therefore, the one aspect described above increases a likelihood of moving the gas out of the conductive resin layer, as compared with a configuration in which the conductive resin layer is not formed with the ridge.

Consequently, the one aspect described above can prevent peel-off of the conductive resin layer.

The conductive resin layer has a higher electrical resistance than an electrode layer including no resin. A configuration in which a thickness of the conductive resin layer is large has a higher electrical resistance than a configuration in which a thickness of the conductive resin layer is small.

In the one aspect described above, the conductive resin layer includes the region, on the side surface, having the thickness smaller than the thickness at the ridge. Therefore, the one aspect described above prevents an increase in ESR (equivalent series resistance) of the conductive resin layer.

In the one aspect described above, when viewed from a direction orthogonal to the side surface, the ridge may overlap with a center of the side surface.

A configuration in which the ridge overlaps with the center of the side surface tends to move the gas generated from the moisture from the position corresponding to the center of the side surface toward the position corresponding to the end edge of the side surface. Therefore, this configuration can reliably prevent the peel-off of the conductive resin layer.

In the one aspect described above, the side surface may have a rectangular shape, and the at least one direction may include a direction parallel to one side of the side surface having the rectangular shape.

A configuration in which the at least one direction includes the direction parallel to the one side of the side surface having the rectangular shape tends to move the gas generated from the moisture toward the position corresponding to the end edge of the side surface. Therefore, this configuration can reliably prevent the peel-off of the conductive resin layer.

In the one aspect described above, the side surface may have a rectangular shape, and the at least one direction may include a direction along a diagonal of the side surface having the rectangular shape.

A configuration in which the at least one direction includes the direction along the diagonal of the side surface having the rectangular shape tends to move the gas generated from the moisture toward the position corresponding to the end edge of the side surface. Therefore, this configuration can reliably prevent the peel-off of the conductive resin layer.

In the one aspect described above, the ridge may be formed along a plurality of directions including the at least one direction and intersecting each other, on the side surface.

A configuration in which the ridge is formed along the plurality of directions intersecting each other tends to move the gas generated from the moisture toward a plurality of position corresponding to the end edge of the side surface. Therefore, this configuration can further reliably prevent the peel-off of the conductive resin layer.

In the one aspect described above, the side surface may have a rectangular shape, and the ridge may have a length in the at least one direction that is larger than or equal to half of a length of a diagonal of the side surface having the rectangular shape and smaller than or equal to the length of the diagonal.

A configuration in which the ridge has the length described above tends to move the gas generated from the moisture along the at least one direction toward the position corresponding to the end edge of the side surface. Therefore, this configuration can reliably prevent the peel-off of the conductive resin layer.

In the one aspect described above, the ridge may have a shape in which a width in the at least one direction is larger than a width in a direction orthogonal to the at least one direction, in a cross-section obtained by cutting the ridge at a plane parallel to the side surface.

A configuration in which the ridge has the shape described above tends to move the gas generated from the moisture along the at least one direction toward the position corresponding to the end edge of the side surface. Therefore, this configuration can reliably prevent the peel-off of the conductive resin layer.

In the one aspect described above, the ridge may have an oval shape when viewed from a direction orthogonal to the side surface.

A configuration in which the ridge has the oval shape described above tends to move the gas generated from the moisture along the at least one direction toward the position corresponding to the end edge of the side surface. Therefore, this configuration can reliably prevent the peel-off of the conductive resin layer.

In the one aspect described above, the ridge may have a shape in which a region with gradual change in height is larger in a cross-section cut by a plane orthogonal to the side surface and along the at least one direction, as compared with in a cross-section cut by a plane orthogonal to both the side surface and the at least one direction.

A configuration in which the ridge has the shape described above tends to move the gas generated from the moisture along the at least one direction toward the position corresponding to the end edge of the side surface. Therefore, this configuration can reliably prevent the peel-off of the conductive resin layer.

In the one aspect described above, the ridge may have a shape in which a change in height in a cross-section cut by a plane orthogonal to both the side surface and the at least one direction is steeper than a change in height in a cross-section cut by a plane orthogonal to the side surface and along the at least one direction.

In a configuration in which the ridge has the shape described above, the ridge has a shape in which the change in height in the cross-section cut by the plane orthogonal to the side surface and along the at least one direction is more gradual than the change in height in the cross-section cut by the plane orthogonal to both the side surface and the at least one direction. Therefore, this configuration tends to move the gas generated from the moisture along the at least one direction toward the position corresponding to the end edge of the side surface. This configuration can reliably prevent the peel-off of the conductive resin layer.

### BRIEF DESCRIPTION OF THE DRAWINGS

FIG. 1 is a perspective view of a multilayer capacitor according to a first example;

FIG. 2 is a view illustrating a cross-sectional configuration of the multilayer capacitor according to the first example;

FIG. 3 is a view illustrating a cross-sectional configuration of the multilayer capacitor according to the first example;

FIG. 4 is a view illustrating a cross-sectional configuration of the multilayer capacitor according to the first example;

FIG. 5 is a plan view illustrating a second electrode layer;

FIG. 6 is a plan view illustrating a second electrode layer;

FIG. 7 is a plan view illustrating a second electrode layer;

FIG. 8 is a plan view illustrating a second electrode layer;

FIG. 9 is a view illustrating an electronic component device according to a second example; and

FIG. 10 is a view illustrating an electronic component device according to a third example.

### DETAILED DESCRIPTION

In the following description, with reference to the drawings, the same reference numbers are assigned to the same components or to similar components having the same function, and overlapping description is omitted.

### First Example

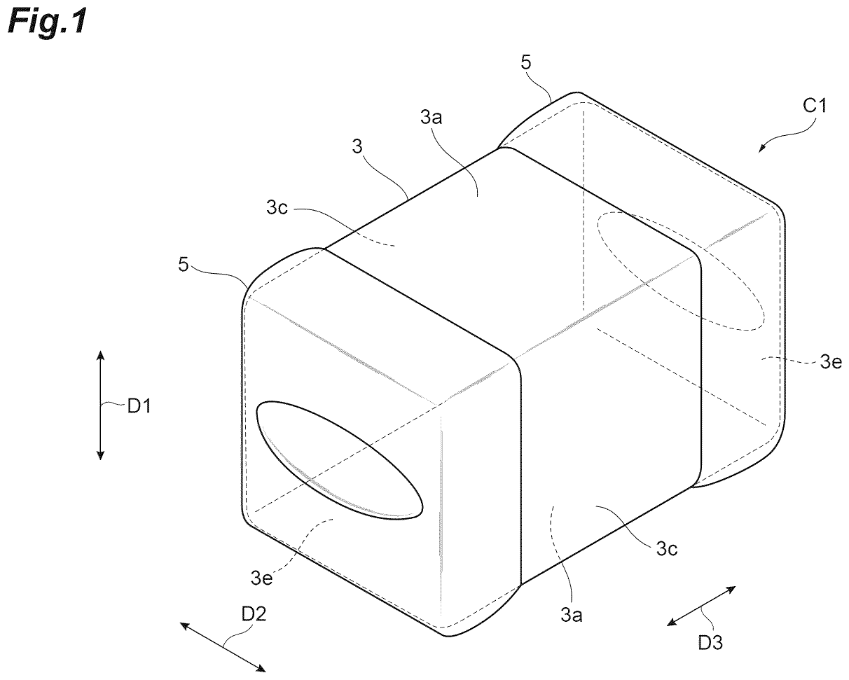

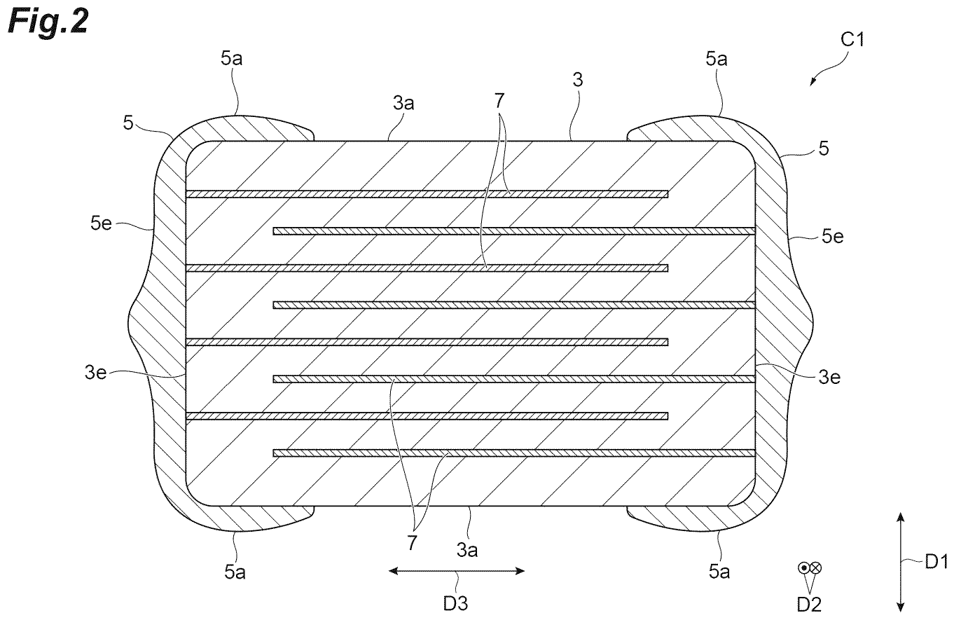

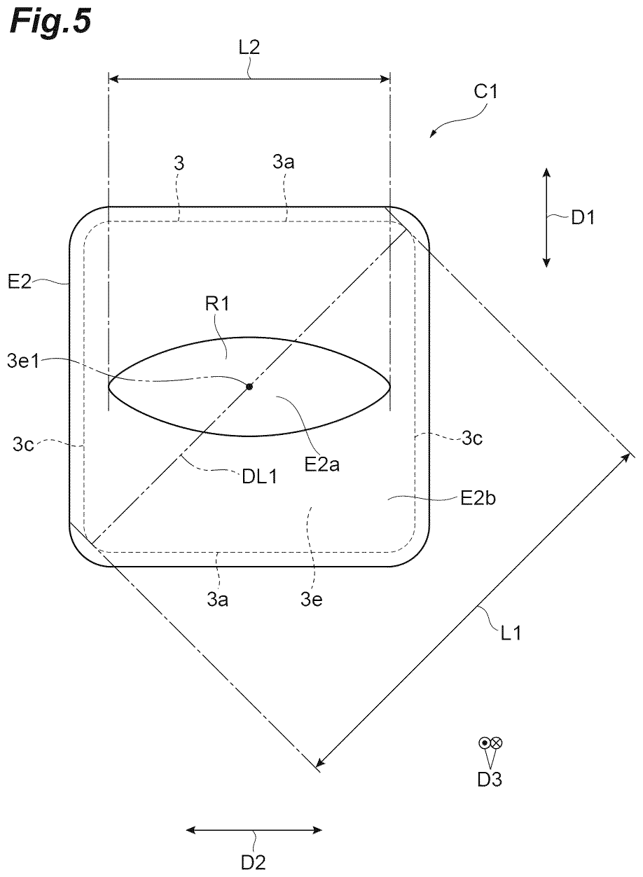

A configuration of a multilayer capacitor C1 according to the first example will be described with reference to FIGS. 1 to 5. FIG. 1 is a perspective view of a multilayer capacitor according to the first example. FIGS. 2, 3, and 4 are views illustrating a cross-sectional configuration of the multilayer capacitor according to the first example. FIG. 5 is a plan view illustrating a second electrode layer. In the first example, an electronic component includes, for example, the multilayer capacitor C1.

As illustrated in FIG. 1, the multilayer capacitor C1 includes an element body 3 of a rectangular parallelepiped shape, a plurality of external electrodes 5. The plurality of external electrodes 5 are disposed on the element body 3. The plurality of external electrodes 5 are separated from each other. For example, the multilayer capacitor C1 includes a pair of external electrodes 5. The rectangular parallelepiped shape includes a rectangular parallelepiped shape in which corners and ridges are chamfered, or a rectangular parallelepiped shape in which the corners and ridges are rounded.

The element body 3 includes a pair of side surfaces 3a opposing each other, a pair of side surfaces 3c opposing each other, and a pair of side surfaces 3e opposing each other. Each of the side surfaces 3a, 3c, and 3e has a substantially rectangular shape. The rectangular shape includes, for example, a rectangular shape in which corners are chamfered or a rectangular shape in which corners are rounded.

The pair of side surfaces 3a oppose each other in a direction D1. The pair of side surfaces 3c oppose each other in a direction D2. The pair of side surfaces 3e oppose each other in a direction D3. The direction D1 intersects the direction D2 and intersects the direction D3. The direction D2 intersects the direction D3. For example, the direction D1, the direction D2, and the direction D3 are orthogonal to each other. The side surfaces 3a are orthogonal to the direction D1. The side surfaces 3c are orthogonal to the direction D2. The side surfaces 3e are orthogonal to the direction D3.

The multilayer capacitor C1 is solder-mounted on an electronic device, for example. The electronic device includes, for example, a circuit board or an electronic component. In the multilayer capacitor C1, for example, one of four side surfaces 3a and 3c opposes the electronic device. The one of four side surfaces 3a and 3c is arranged to constitute a mounting surface. The one of four side surfaces 3a and 3c includes the mounting surface.

The side surfaces 3e extend in the direction D1 to couple the pair of side surfaces 3a. The side surfaces 3e extend in the direction D2 to couple the pair of side surfaces 3c. The side surfaces 3a extend in the direction D3 to couple the pair of side surfaces 3e. The side surfaces 3c extend in the direction D3 to couple the pair of side surfaces 3e.

A length of the element body 3 in the direction D1 is 0.1 to 6.3 mm. A length of the element body 3 in the direction D2 is 0.1 to 3.2 mm. A length of the element body 3 in the direction D3 is 0.2 to 7.5 mm. In the element body 3, for example, the direction D3 is a longitudinal direction. The length of the element body 3 in the direction D1 is a height of the element body 3. The length of the element body 3 in the direction D2 is a width of the element body 3. The length of the element body 3 in the direction D3 is a longitudinal length of the element body 3.

The element body 3 is configured through laminating a plurality of dielectric layers in the direction D1. The element body 3 includes a plurality of laminated dielectric layers. In the element body 3, a lamination direction of the plurality of dielectric layers coincides with the direction D1. Each dielectric layer includes, for example, a sintered body of a ceramic green sheet containing a dielectric material. Examples of the dielectric material include dielectric ceramics. Examples of the dielectric ceramics include BaTiO₃-based, Ba (Ti, Zr)O₃-based, or (Ba, Ca)TiO₃-based dielectric ceramics. In the actual element body 3, each of the dielectric layers is integrated to such an extent that a boundary between the dielectric layers cannot be visually recognized. In the element body 3, the lamination direction of the plurality of dielectric layers may coincide with the direction D2.

As illustrated in FIGS. 1 to 4, the external electrodes 5 are disposed at both ends of the element body 3 in the direction D3. Each external electrode 5 is disposed on a corresponding side surface 3e of the pair of side surfaces 3e. For example, each external electrode 5 is disposed on the side surface 3e and the side surfaces 3a and 3c. For example, each external electrode 5 is disposed on a ridge portion between the side surface 3e and the side surface 3a, a ridge portion between the side surface 3e and the side surface 3c, and a ridge portion between the side surface 3a and the side surface 3c.

The external electrode 5 includes a plurality of electrode portions 5a, 5c, and 5e. The electrode portion 5a is positioned on the side surface 3a. The electrode portion 5c is positioned on the side surface 3c. The electrode portion 5e is positioned on the side surface 3e. The external electrode 5 may include an electrode portion on the ridge portion between the side surface 3e and the side surface 3a, an electrode portion on the ridge portion between the side surface 3e and the side surface 3c, and an electrode portion on the ridge portion between the side surface 3a and the side surface 3c.

Each external electrode 5 is formed on five surfaces of the pair of side surfaces 3a, the pair of side surfaces 3c, and the side surface 3e. The electrode portions 5a, 5b, 5c, and 5e adjacent to each other are coupled to each other and are electrically connected to each other. The external electrode 5 includes a first electrode layer E1, a second electrode layer E2, and a third electrode layer E3. Each of the electrode portions 5a, 5c, and 5e includes the first electrode layer E1, the second electrode layer E2, and the third electrode layer E3, for example. The third electrode layer E3 is arranged to include the outermost layer of the external electrode 5.

The first electrode layer E1 of the electrode portion 5a is disposed on the side surface 3a. The first electrode layer E1 of the electrode portion 5a is formed to cover a partial region of the side surface 3a. The first electrode layer E1 of the electrode portion 5a is in contact with the partial region of the side surface 3a. The partial region of the side surface 3a is positioned closer to the corresponding side surface 3e, for example. The first electrode layer E1 of the electrode portion 5a is disposed on the ridge portion between the side surface 3a and the side surface 3e. The first electrode layer E1 may not be disposed on the side surface 3a.

The second electrode layer E2 of the electrode portion 5a is disposed on the side surface 3a. The second electrode layer E2 of the electrode portion 5a is in contact with a part of the side surface 3a. The above-described part of the side surface 3a is, for example, a partial region, of the side surface 3a, closer to the corresponding side surface 3e. The second electrode layer E2 of the electrode portion 5a is formed to cover the above-described part of the side surface 3a. The second electrode layer E2 of the electrode portion 5a directly covers the above-described part of the side surface 3a.

The third electrode layer E3 of the electrode portion 5a is disposed on the second electrode layer E2. In the electrode portion 5a, the third electrode layer E3 covers the entire second electrode layer E2. In the electrode portion 5a, the third electrode layer E3 is in contact with the entire second electrode layer E2. In the electrode portion 5a, the third electrode layer E3 is in direct contact with the second electrode layer E2. Even in a configuration in which the first electrode layer E1 is disposed on the side surface 3a, in the electrode portion 5a, the third electrode layer E3 is not in direct contact with the first electrode layer El. The electrode portion 5a has a two-layered structure including the second electrode layer E2 and the third electrode layer E3, on the side surface 3a. In a configuration in which the first electrode layer E1 of the electrode portion 5a is disposed on the side surface 3a, the electrode portion 5a may have a three-layered structure, on the side surface 3a.

The first electrode layer E1 of the electrode portion 5c is disposed on the side surface 3c. The first electrode layer E1 of the electrode portion 5c is formed to cover a partial region of the side surface 3c. The first electrode layer E1 of the electrode portion 5c is in contact with the partial region of the side surface 3c. The partial region of the side surface 3c is positioned closer to the corresponding side surface 3e, for example. The first electrode layer E1 of the electrode portion 5c is disposed on the ridge portion between the side surface 3c and the side surface 3e. The first electrode layer E1 may not be disposed on the side surface 3c.

The second electrode layer E2 of the electrode portion 5c is disposed on the side surface 3c. The second electrode layer E2 of the electrode portion 5c is in contact with a part of the side surface 3c. The above-described part of the side surface 3c is, for example, a partial region, of the side surface 3c, closer to the corresponding side surface 3e. The second electrode layer E2 of the electrode portion 5c is formed to cover the above-described part of the side surface 3c. The second electrode layer E2 of the electrode portion 5c directly covers the above-described part of the side surface 3c.

The third electrode layer E3 of the electrode portion 5c is disposed on the second electrode layer E2. In the electrode portion 5c, the third electrode layer E3 covers the entire second electrode layer E2. In the electrode portion 5c, the third electrode layer E3 is in contact with the entire second electrode layer E2. In the electrode portion 5c, the third electrode layer E3 is in direct contact with the second electrode layer E2. Even in a configuration in which the first electrode layer E1 is disposed on the side surface 3c, in the electrode portion 5c, the third electrode layer E3 is not in direct contact with the first electrode layer E1. The electrode portion 5c has a two-layered structure including the second electrode layer E2 and the third electrode layer E3, on the side surface 3c. In a configuration in which the first electrode layer E1 of the electrode portion 5c is disposed on the side surface 3c, the electrode portion 5c may have a three-layered structure, on the side surface 3c.

The first electrode layer E1 of the electrode portion 5e is disposed on the side surface 3e. The entire side surface 3e is covered with the first electrode layer E1. The first electrode layer E1 of the electrode portion 5e is in contact with the entire side surface 3e.

The second electrode layer E2 of the electrode portion 5e is disposed on the first electrode layer E1. In the electrode portion 5e, the second electrode layer E2 is in contact with the entire first electrode layer E1. The second electrode layer E2 of the electrode portion 5e is formed to cover the entire side surface 3e. The second electrode layer E2 of the electrode portion 5e indirectly covers the entire side surface 3e such that the first electrode layer E1 is positioned between the second electrode layer E2 and the side surface 3e. The second electrode layer E2 of the electrode portion 5e directly covers the entire first electrode layer E1.

In the electrode portion 5e, the second electrode layer E2 may cover only a part of the side surface 3e. The above-described part of the side surface 3e covered with the second electrode layer E2 is positioned closer to the side surface 3a, for example. In this case, in the electrode portion 5e, the second electrode layer E2 indirectly covers only the above-described part of the side surface 3e such that the first electrode layer E1 is disposed between the second electrode layer E2 and the side surface 3e. In the electrode portion 5e, the second electrode layer E2 directly covers only a part of the first electrode layer E1. That is, the electrode portion 5e includes a region where the first electrode layer E1 is exposed from the second electrode layer E2 and a region where the first electrode layer E1 is covered with the second electrode layer E2.

The third electrode layer E3 of the electrode portion 5e is disposed on the second electrode layer E2. In the electrode portion 5e, the third electrode layer E3 covers the entire second electrode layer E2. In the electrode portion 5e, the third electrode layer E3 is in contact with the entire second electrode layer E2. In the electrode portion 5e, the third electrode layer E3 is in direct contact with the second electrode layer E2. In the electrode portion 5e, the third electrode layer E3 is not in direct contact with the first electrode layer E1.

In the second electrode layer E2, a ridge R1 is formed on the side surface 3e. The second electrode layer E2 includes a region E2a and a region E2b excluding the region E2a. The ridge R1 is formed along the direction D2. For example, the ridge R1 may be formed substantially along the direction D2. The ridge R1 is formed along a direction parallel to the side surface 3a. When viewed from the direction D3, the ridge R1 overlaps a center 3e1 of the side surface 3e. When viewed from the direction D3, the ridge R1 has a substantially oval shape. The substantially oval shape of the ridge R1 includes a substantially elliptical shape or a substantially rounded rectangular shape. The ridge R1 may have a substantially rectangular shape. For example, a longitudinal direction of the substantially oval shape of the ridge R1 includes the direction D2. The ridge R1 may be formed along the direction D1. In this case, the ridge R1 is formed along a direction parallel to the side surface 3c. For example, the ridge R1 may be formed substantially along the direction D1.

As illustrated in FIG. 5, the ridge R1 has a length L2 in the direction D2 that is larger than or equal to half of a length L1 of a diagonal line DL1 of the side surface 3e and less than or equal to the length L1 of the diagonal line DL1. The length L1 of the diagonal line DL1 is defined as follows, for example.

In the element body 3 in which one plane including the side surface 3e includes the end edges of the side surface 3e, the length L1 of the diagonal line DL1 is defined on the side surface 3e. In the element body 3 in which one plane including the side surface 3e does not include the end edges of the side surface 3e, the length L1 of the diagonal line DL1 is defined on a region included in a plane including the side surface 3e and orthogonal to four planes each including a corresponding side surface of the four side surfaces 3a and 3c, the region being partitioned by the four planes.

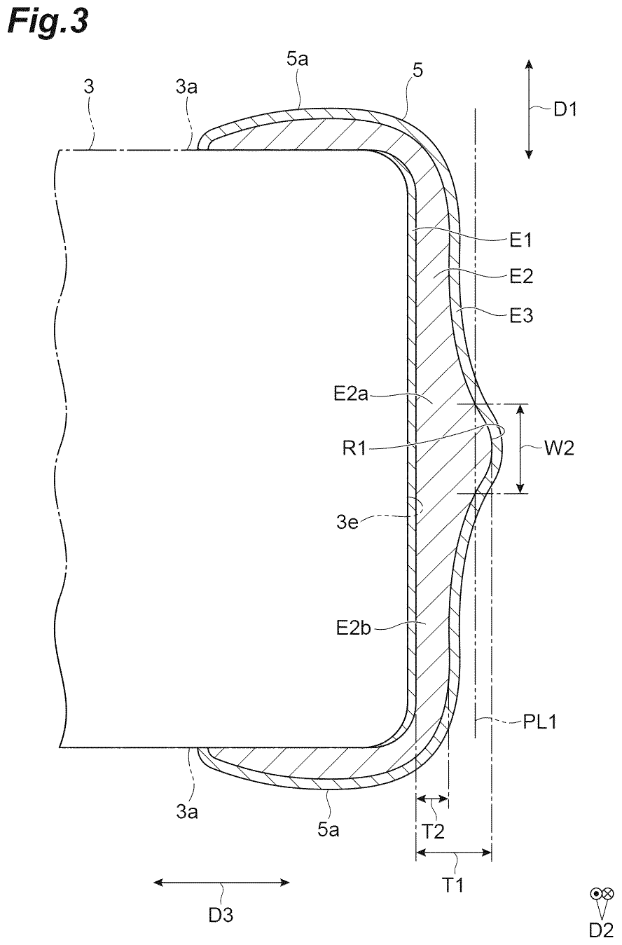

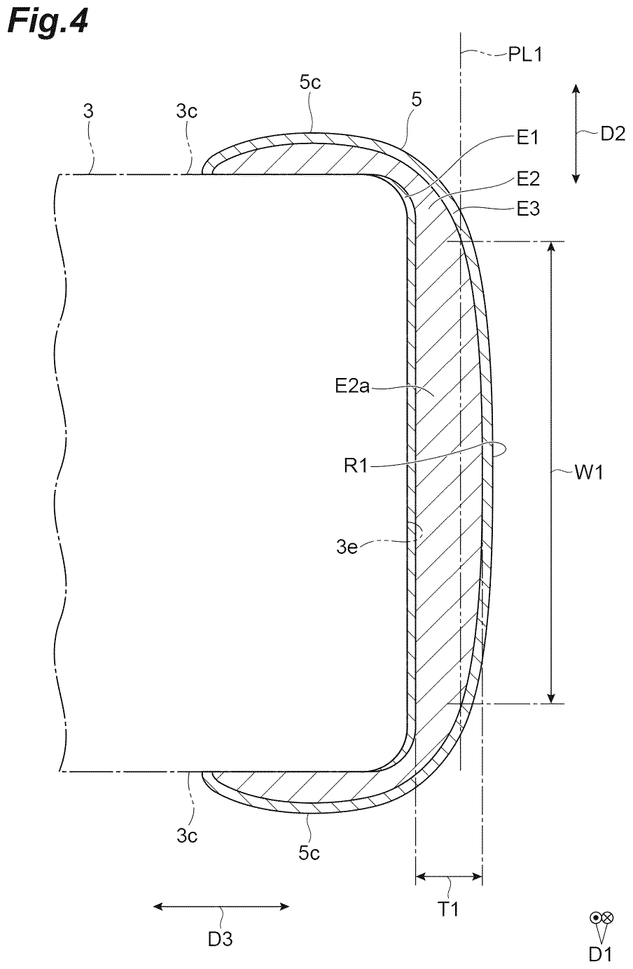

In the ridge R1, the second electrode layer E2 protrudes toward the outside of the element body 3 since an increase rate in a thickness of the second electrode layer E2 is larger in a central region including the center 3e1 of the side surface 3e than in a peripheral region other than the central region. In the second electrode layer E2, the above-described increase rate is different between the region E2a and the region E2b. The above-described increase rate in the region E2b is larger than the above-described increase rate in the region E2a. Due to this difference in the above-described increase rates, the second electrode layer E2 is formed with the ridge R1. The ridge R1 includes a protruding region between a point at which the increase rate in the thickness of the second electrode layer E2 changes and a center of the second electrode layer E2. An outer edge of the ridge R1 includes a changing point at which the increase rate in the thickness of the second electrode layer E2 changes. That is, the region E2a includes the ridge R1. As illustrated in FIGS. 3 and 4, the region E2b has a thickness T1 that is smaller than a thickness T2 in the region E2a. The side surface 3e includes a region overlapping with the region E2a and a region overlapping with the region E2b. For example, the region overlapping with the region E2b includes a region other than the region overlapping with the region E2a, in the side surface 3e. The third electrode layer E3 has an outer shape corresponding to an outer shape of the second electrode layer E2, and the third electrode layer E3 positioned on the ridge R1 protrudes toward the outside of the element body 3.

The ridge R1 has a shape in which a width W1 is larger than a width W2. The width W1 is a length of the ridge R1 in the direction D2 on cross-section obtained by cutting the ridge R1 with a plane PL1. The width W2 is a length of the ridge R1 in the direction D1 on cross-section obtained by cutting the ridge R1 with the plane PL1. For example, a maximum value of the width W1 corresponds to the length L2. The plane PL1 includes a plane that is parallel to a plane including the side surface 3e and is separated from the side surface 3e by a predetermined length.

The widths W1 and W2 can be obtained, for example, as follows.

A cross-sectional photograph of the multilayer capacitor C1 including the second electrode layer E2 is acquired. The cross-sectional photograph is, for example, a photograph of a cross-section of the multilayer capacitor C1 when cut along a plane PL1 parallel to the central region including the center 3e1 of the side surface 3e. Image processing of the acquired cross-sectional photograph is performed using software. Based on the result of this image processing, a boundary of the second electrode layer E2 is determined, and the widths W1 and W2 on the acquired cross-sectional photograph are calculated. The widths W1 and W2 may be, for example, average values of a plurality of measurement results.

As illustrated in FIGS. 3 and 4, the ridge R1 has a shape in which a region with gradual change in height is larger in a cross-section cut by a plane orthogonal to the side surface 3e and along the direction D2, as compared with in a cross-section cut by a plane orthogonal to both the side surface 3e and the direction D2. FIG. 3 illustrates a cross-section cut by the plane orthogonal to both the side surface 3e and the direction D2. FIG. 4 illustrates a cross-section cut by a plane orthogonal to the side surface 3e and along the direction D2. The ridge R1 has a shape in which a change in height in the cross-section cut by the plane orthogonal to both the side surface 3e and the direction D2 is steeper than a change in height in the cross-section cut by the plane orthogonal to the side surface 3e and along the direction D2.

The first electrode layer E1 is formed from sintering electrically conductive paste applied onto the surface of the element body 3. The first electrode layer E1 is formed to cover the side surface 3e. The first electrode layer E1 is formed from sintering a metal component included in the electrically conductive paste. The metal component included in the electrically conductive paste includes, for example, metal particles. The first electrode layer E1 includes a sintered metal layer. The first electrode layer E1 includes the sintered metal layer formed on the element body 3. For example, the first electrode layer E1 includes a sintered metal layer made of Cu. The first electrode layer E1 may include a sintered metal layer made of Ni. The first electrode layer E1 includes a base metal. The electrically conductive paste includes, for example, particles made of Cu or Ni, a glass component, an organic binder, and an organic solvent. The first electrode layers E1 included in the electrode portions 5a, 5c, and 5e are integrally formed.

The second electrode layer E2 is formed from curing electrically conductive resin paste applied onto the first electrode layer E1. The second electrode layer E2 is formed on both the first electrode layer E1 and the element body 3. The first electrode layer E1 includes an underlying metal layer for forming the second electrode layer E2. The second electrode layer E2 includes an electrically conductive resin layer that covers the first electrode layer E1. The electrically conductive resin paste includes, for example, a curable resin, an electrically conductive material, and an organic solvent. The resin includes, for example, a thermosetting resin. The conductive material includes, for example, metal particles. The metal particles include, for example, silver particles or copper particles. The thermosetting resin includes, for example, a phenol resin, an acrylic resin, a silicone resin, an epoxy resin, or a polyimide resin. The second electrode layers E2 included in the electrode portions 5a, 5c, and 5e are integrally formed.

Applying the electrically conductive resin paste includes, for example, the following processes.

One process includes forming a layer made of an electrically conductive resin paste and having a predetermined thickness, on the element body 3, and applying the electrically conductive resin paste to a region where the ridge R1 is to be formed in the layer having the predetermined thickness and positioned on the side surface 3e.

Another process includes forming a layer made of an electrically conductive resin paste and having a predetermined thickness, on the element body 3, and removing a part of the electrically conductive resin paste positioned in a region other than a region where the ridge R1 is to be formed, in the layer having the predetermined thickness and positioned on the side surface 3e.

Through any of the processes described above, the ridge R1 can be formed on the second electrode layer E2, on the side surface 3e.

As described above, the electrically conductive resin paste includes a resin composition including the curable resin and the organic solvent. In this resin composition, the organic solvent is vaporized. A gas is generated in the electrically conductive resin paste due to vaporization of the organic solvent. The gas generated by the vaporization of the organic solvent directly reaches a surface of the electrically conductive resin paste from various places, in the electrically conductive resin paste, where the organic solvent is present, and escapes from the electrically conductive resin paste. In the electrically conductive resin paste, voids are formed at each of the various places in the electrically conductive resin paste and open cell foam connecting these voids is formed, as paths of the gas generated by vaporization of the organic solvent.

The gas generated by vaporization of the organic solvent is released from the surface of the electrically conductive resin paste before curing to the outside of the electrically conductive resin paste. Openings connected to the open cell foam is formed at the surface of the electrically conductive resin paste. The open cell foam is formed so as to communicate the openings formed at the electrically conductive resin paste with the voids generated by vaporization of the organic solvent at the various places where the organic solvent is present. The openings formed at a surface of the second electrode layer E2 are also formed corresponding to the various places where the organic solvent is present. Therefore, the open cell foam can open at an end edge of the second electrode layer E2.

The formation of the voids and the open cell foam in the second electrode layer E2 can be controlled due to, for example, a type and content ratio of organic solvent used as well as conditions under which the electrically conductive resin paste is cured. The curing conditions of the electrically conductive resin paste include, for example, the temperature and pressure of the atmosphere. The formation of the voids and the open cell foam in the electrically conductive resin paste is a matter generally known to those skilled in the art, and further detailed description thereof will be omitted.

The third electrode layer E3 is formed on the second electrode layer E2 using a plating method. The third electrode layer E3 may have a multilayer structure. In this case, the third electrode layer E3 includes, for example, an Ni plating layer and a solder plating layer. The Ni plating layer is formed on the second electrode layer E2. The solder plating layer is formed on the Ni plating layer. The solder plating layer covers the Ni plating layer. The Ni plating layer has better solder leach resistance than the metal included in the second electrode layer E2. The third electrode layer E3 may include an Sn plating layer, a Cu plating layer, or an Au plating layer instead of the Ni plating layer. The solder plating layer includes, for example, an Sn plating layer, an Sn-Ag alloy plating layer, an Sn-Bi alloy plating layer, or an Sn-Cu alloy plating layer. The third electrode layers E3 included in the electrode portions 5a, 5c, and 5e are integrally formed.

The third electrode layer E3 is formed using a so-called electrolytic plating method. When forming a plating layer using the electrolytic plating method, a metal that constitutes the plating layer, for example, deposits on an electrically conductive material used as a base and grows into a plating film. When forming the plating layer on the second electrode layer E2, the metal that constitutes the plating layer, for example, deposits on the electrically conductive materials, among the electrically conductive materials included in the second electrode layer E2, exposed on the surface of the second electrode layer E2 and grows into plating film. The plating film grows on and along the surfaces of the second electrode layer E2, starting from the electrically conductive material exposed on the surfaces of the second electrode layer E2.

The element body 3 tends not to have electrically conductivity. Therefore, the plating film, that is, the third electrode layer E3 is not in close contact with the element body 3. There is a gap between the third electrode layer E3 and the element body 3. The gap between the third electrode layer E3 and the element body 3 communicate with the openings, among the openings formed in the second electrode layer E2, positioned at and in the vicinity of the end edge of the second electrode layer E2. The gap between the third electrode layer E3 and the element body 3 communicate with the open cell foam formed in the second electrode layer E2.

The formation of the plating layer can be controlled due to a temperature and an electric-current value during plating as well as a plating time. The formation of the plating layer is a matter generally known to those skilled in the art, and further detailed description thereof will be omitted.

As illustrated in FIG. 2, the multilayer capacitor C1 includes a plurality of internal electrodes 7. Each of the internal electrodes 7 is included in an internal conductor disposed in the element body 3. The internal electrodes 7 are disposed in different positions (layers) in the direction D1. The internal electrodes 7 are alternately disposed in the element body 3 to oppose each other in the direction D1 with an interval therebetween.

The external electrode 5 is electrically connected to a corresponding internal electrode 7 of the plurality of internal electrodes 7. The internal electrode 7 includes an end exposed to a corresponding side surface 3e of the pair of side surfaces 3e.

The electrode portion 5e entirely covers the end of the internal electrode 7 exposed to the side surface 3e on which the electrode portion 5e is disposed. The electrode portion 5e is directly connected to the corresponding internal electrode 7. In the electrode portion 5e, the first electrode layer E1 is formed on the side surface 3e to be connected to the end of the corresponding internal electrode 7.

The plurality of internal electrodes 7 include electrodes having different polarities from each other. The internal electrodes 7 having different polarities from each other are alternately disposed. The internal electrodes 7 having different polarities from each other are disposed in different positions (layers) in the direction D1. Each of the plurality of internal electrodes 7 includes the end exposed to the corresponding side surface 3e.

The internal electrodes 7 are made of an electrically conductive material that is commonly used as an internal conductor of a multilayer electronic component. The electrically conductive material includes, for example, a base metal. The electrically conductive material includes, for example, Ni or Cu. The internal electrodes 7 are configured as a sintered body of electrically conductive paste containing the electrically conductive material described above. For example, the internal electrodes 7 are made of Ni.

In the multilayer capacitor C1, as described above, the second electrode layer E2 tends to include the open cell foam extending to the end edge of the second electrode layer E2, for example, during forming the second electrode layer E2. The open cell foam can include movement paths of a gas generated from moisture. The gas that has reached the end edge of the second electrode layer E2 can be emitted outside the second electrode layer E2. A configuration with a thicker second electrode layer E2 increases, for example, the number of the movement paths of the gas, as compared with a configuration with a thinner second electrode layer E2.

In the multilayer capacitor C1, the second electrode layer E2 included in the electrode portion 5e is formed with the ridge R1. A thickness of the second electrode layer E2 of the electrode portion 5e tends to increase in thickness at the region E2a. Therefore, the second electrode layer E2 of the electrode portion 5e increases the number of the movement paths of the gas at the region E2a.

The ridge R1 is formed along the at least one direction, on the side surface 3e. Therefore, even when moisture absorbed by the resin is gasified in the second electrode layer E2 of the electrode portion 5e, a gas generated from the moisture tends to move in the at least one direction within the region E2a. In the second electrode layer E2, the gas moving through the region E2a tends to move towards a position corresponding to the end edge of the side surface 3e. In the second electrode layer E2, the position corresponding to the end edge of the side surface 3e is closer to the end edge of the second electrode layer E2 than a position corresponding to a center of the side surface 3e. The multilayer capacitor C1 tends to move the gas generated from the moisture to a position close to the end edge of the second electrode layer E2. Therefore, the multilayer capacitor C1 increases a likelihood of moving the gas out of the second electrode layer E2, as compared with a configuration in which the second electrode layer E2 is not formed with the ridge R1.

Consequently, the multilayer capacitor C1 can prevent peel-off of the second electrode layer E2.

The resin included in the second electrode layer E2 can include movement paths of moisture. The moisture that has reached the end edge of the second electrode layer E2 may, for example, be gasified and be emitted outside the second electrode layer E2. A configuration with a thicker second electrode layer E2 increases the number of the movement paths of the moisture, as compared with a configuration with a thinner second electrode layer E2.

As described above, the thickness of the second electrode layer E2 of the electrode portion 5e tends to increase in thickness at the region E2a. Therefore, the second electrode layer E2 of the electrode portion 5e increases the number of the movement paths of the moisture at the region E2a.

The moisture included in the resin in the second electrode layer E2 of the electrode portion 5e tends to move in the at least one direction within the region E2a. In the second electrode layer E2, the moisture moving through the region E2a tends to move towards the position corresponding to the end edge of the side surface 3e. The multilayer capacitor C1 tends to move the moisture to the position close to the end edge of the second electrode layer E2. Therefore, the multilayer capacitor C1 increases a likelihood of moving the moisture out of the second electrode layer E2, as compared with the configuration in which the second electrode layer E2 is not formed with the ridge R1.

Consequently, the multilayer capacitor C1 can prevent peel-off of the second electrode layer E2.

The gas generated from the moisture in the second electrode layer E2 can ultimately be discharged outside the external electrode 5 through the gap between the element body 3 and the third electrode layer E3.

The second electrode layer E2 has a higher electrical resistance than an electrode layer including no resin. A configuration in which a thickness of the second electrode layer E2 is large has a higher electrical resistance than a configuration in which a thickness of the second electrode layer E2 is small.

In the multilayer capacitor C1, the second electrode layer E2 includes the region E2b, on the side surface 3e, having the thickness smaller than the thickness at the ridge R1. Therefore, the multilayer capacitor C1 prevents an increase in ESR (equivalent series resistance) of the second electrode layer E2.

In the multilayer capacitor C1, when viewed from the direction orthogonal to the side surface 3e, the ridge R1 overlaps with the center 3e1 of the side surface 3e. Therefore, the multilayer capacitor C1 tends to move the gas generated from the moisture from the position corresponding to the center 3e1 of the side surface 3e toward the position corresponding to the end edge of the side surface 3e. Consequently, the multilayer capacitor C1 can reliably prevent the peel-off of the second electrode layer E2.

In the multilayer capacitor C1, the side surface 3e has the rectangular shape. The ridge R1 is formed along a direction parallel to one side of the side surface 3e, on the side surface 3e. The at least one direction described above includes the direction parallel to the one side of the side surface 3e having the rectangular shape. For example, the at least one direction described above includes the direction D2. Therefore, the multilayer capacitor C1 tends to move the gas generated from the moisture toward the position corresponding to the end edge of the side surface 3e. Consequently, the multilayer capacitor C1 can reliably prevent the peel-off of the second electrode layer E2.

In the multilayer capacitor C1, the side surface 3e has the rectangular shape. The ridge R1 has the length L2 in the above-described direction parallel to the one side of the side surface 3e that is larger than or equal to half of the length L1 of the diagonal line DL1 of the side surface 3e having the rectangular shape and less than or equal to the length L1 of the diagonal line DL1. Therefore, the multilayer capacitor C1 tends to move the gas generated from the moisture along the above-described direction parallel to the one side of the side surface 3e toward the position corresponding to the end edge of the side surface 3e. Consequently, the multilayer capacitor C1 can reliably prevent the peel-off of the second electrode layer E2.

In the multilayer capacitor C1, the ridge R1 has the shape in which the width W1 is larger than the width W2. Therefore, the multilayer capacitor C1 tends to move the gas generated from the moisture along the above-described direction parallel to the one side of the side surface 3e toward the position corresponding to the end edge of the side surface 3e. Consequently, the multilayer capacitor C1 can reliably prevent the peel-off of the second electrode layer E2.

In the multilayer capacitor C1, the ridge R1 has the substantially oval shape when viewed from the direction orthogonal to the side surface 3e. Therefore, the multilayer capacitor C1 tends to move the gas generated from the moisture along the above-described direction parallel to the one side of the side surface 3e toward the position corresponding to the end edge of the side surface 3e. Consequently, the multilayer capacitor C1 can reliably prevent the peel-off of the second electrode layer E2.

In the multilayer capacitor C1, the ridge R1 has the shape in which the region with gradual change in height is larger in the cross-section cut by the plane orthogonal to the side surface 3e and along the above-described direction parallel to the one side of the side surface 3e, as compared with in the cross-section cut by the plane orthogonal to both the side surface 3e and the above-described direction parallel to the one side of the side surface 3e. Therefore, the multilayer capacitor C1 tends to move the gas generated from the moisture along the above-described direction parallel to the one side of the side surface 3e toward the position corresponding to the end edge of the side surface 3e. Consequently, the multilayer capacitor C1 can reliably prevent the peel-off of the second electrode layer E2.

In the multilayer capacitor C1, the ridge R1 has the shape in which the change in height in the cross-section cut by the plane orthogonal to both the side surface 3e and the above-described direction parallel to the one side of the side surface 3e is steeper than the change in height in the cross-section cut by the plane orthogonal to the side surface 3e and along the above-described direction parallel to the one side of the side surface 3e. Therefore, in the multilayer capacitor C1, the ridge R1 has a shape in which the change in height in the cross-section cut by the plane orthogonal to the side surface 3e and along the above-described direction parallel to the one side of the side surface 3e is more gradual than the change in height in the cross-section cut by the plane orthogonal to both the side surface 3e and the above-described direction parallel to the one side of the side surface 3e. The multilayer capacitor C1 tends to move the gas generated from the moisture along the above-described direction parallel to the one side of the side surface 3e toward the position corresponding to the end edge of the side surface 3e. Consequently, the multilayer capacitor C1 can reliably prevent the peel-off of the second electrode layer E2.

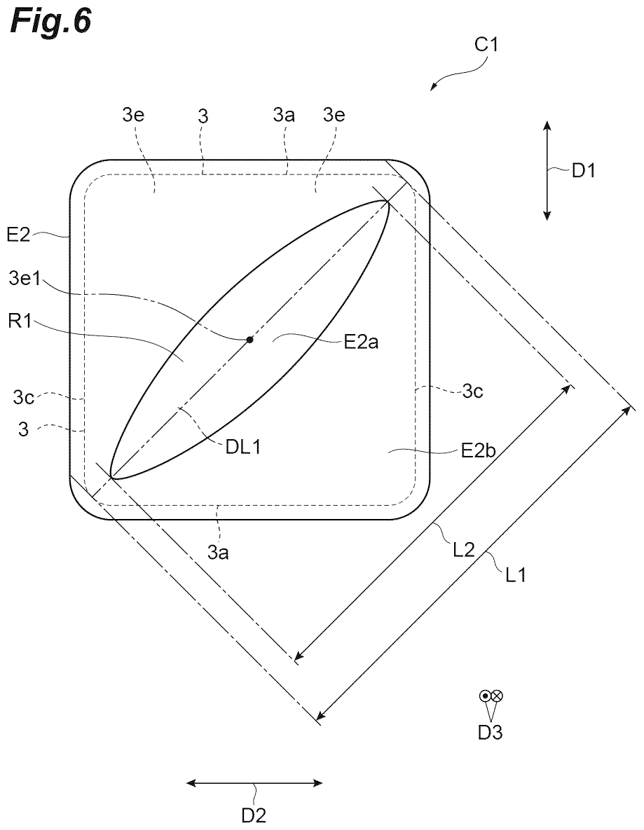

A configuration of a multilayer capacitor C1 according to one modified example of the first example will be described with reference to FIG. 6. FIG. 6 is a plan view illustrating a second electrode layer. The multilayer capacitor C1 according to this modified example is generally similar to or the same as the multilayer capacitor C1 according to the first example. However, the multilayer capacitor C1 according to this modified example is different from the multilayer capacitor C1 according to the first example in a configuration of the external electrode 5. Hereinafter, differences between the above-described first example and this modified example will be mainly described.

The multilayer capacitor C1 in accordance with this modified example also includes the pair of external electrodes 5.

In the second electrode layer E2, a ridge R1 is formed on the side surface 3e. The ridge R1 is formed along the diagonal line DL1. For example, the ridge R1 may be formed substantially along the diagonal line DL1. When viewed from the direction D3, the ridge R1 has a substantially oval shape. For example, a longitudinal direction of the substantially oval shape of the ridge R1 includes a direction in which the diagonal line DL1 extends. The ridge R1 may be formed along a direction intersecting the direction in which the diagonal line DL1 illustrated in FIG. 6 extends. For example, the ridge R1 may be formed substantially along the direction intersecting the direction in which the diagonal line DL1 illustrated in FIG. 6 extends.

In this modified example, the ridge R1 has a length L2 in the direction in which the diagonal line DL1 extends, the length L2 being larger than or equal to half of a length L1 of the diagonal DL1 and less than or equal to the length L1 of the diagonal DL1.

In the multilayer capacitor C1 according to this modified example, the side surface 3e has a rectangular shape. The at least one direction described above includes a direction along the diagonal line DL1 of the side surface 3e having the rectangular shape. Therefore, the multilayer capacitor C1 according to this modified example tends to move the gas generated from the moisture toward the position corresponding to the end edge of the side surface 3e. Consequently, the multilayer capacitor C1 according to this modified example can reliably prevent the peel-off of the second electrode layer E2.

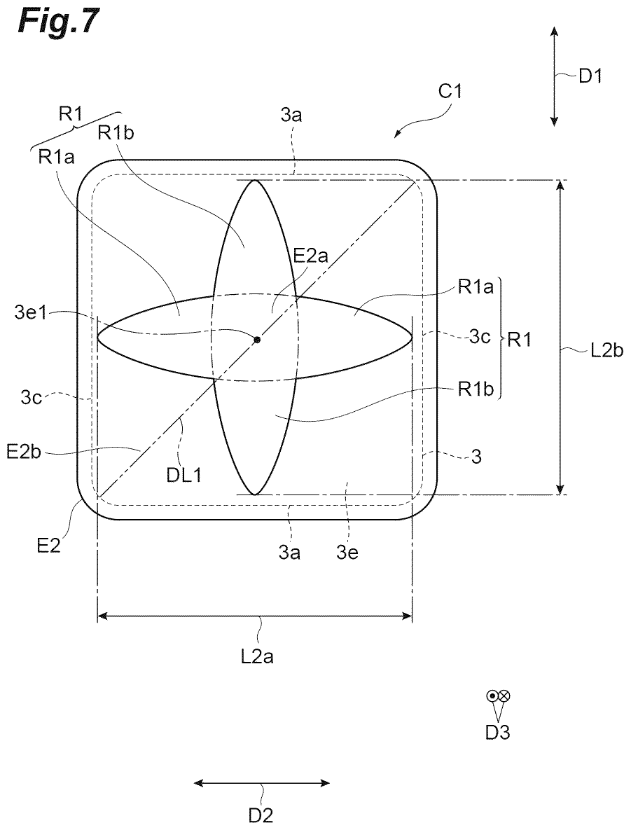

A configuration of a multilayer capacitor C1 according to another modified example of the first example will be described with reference to FIG. 7. FIG. 7 is a plan view illustrating a second electrode layer. The multilayer capacitor C1 according to this modified example is generally similar to or the same as the multilayer capacitor C1 according to the first example. However, the multilayer capacitor C1 according to this modified example is different from the multilayer capacitor C1 according to the first example in a configuration of the external electrode 5. Hereinafter, differences between the above-described first example and this modified example will be mainly described.

The multilayer capacitor C1 in accordance with this modified example also includes the pair of external electrodes 5.

In the second electrode layer E2, a ridge R1 is formed on the side surface 3e. The ridge R1 is formed along the direction D1 and direction D2. The ridge R1 includes a ridge R1a and a ridge R1b. The ridge R1a is formed along the direction D2, and the ridge R1b is formed along the direction D1. For example, the ridge R1 may be formed substantially along the direction D1 and direction D2. For example, the ridge R1a may be formed substantially along the direction D2, and the ridge R1b may be formed substantially along the direction D1. The ridge R1a and the ridge R1b intersect with each other. For example, the ridge R1a and the ridge R1b intersect with each other at approximately 90°. When viewed from the direction D3, each of the ridge R1a and the ridge R1b has a substantially oval shape. A longitudinal direction of the oval shape of the ridge R1a includes the direction D2. A longitudinal direction of the oval shape of the ridge R1b includes the direction D1.

The ridge R1a has a length L2a larger than or equal to half of a length L1 of the diagonal DL1 and less than or equal to the length L1 of the diagonal DL1. The ridge R1b has a length L2b larger than or equal to half of the length L1 of the diagonal DL1 and less than or equal to the length L1 of the diagonal DL1.

In the multilayer capacitor C1 according to this modified example, the ridge is formed along a plurality of directions including the at least one direction and intersecting each other, on the side surface 3e. The multilayer capacitor C1 according to this modified example tends to move the gas generated from the moisture toward a plurality of position corresponding to the end edge of the side surface 3e. Therefore, the multilayer capacitor C1 according to this modified example can further reliably prevent the peel-off of the second electrode layer E2.

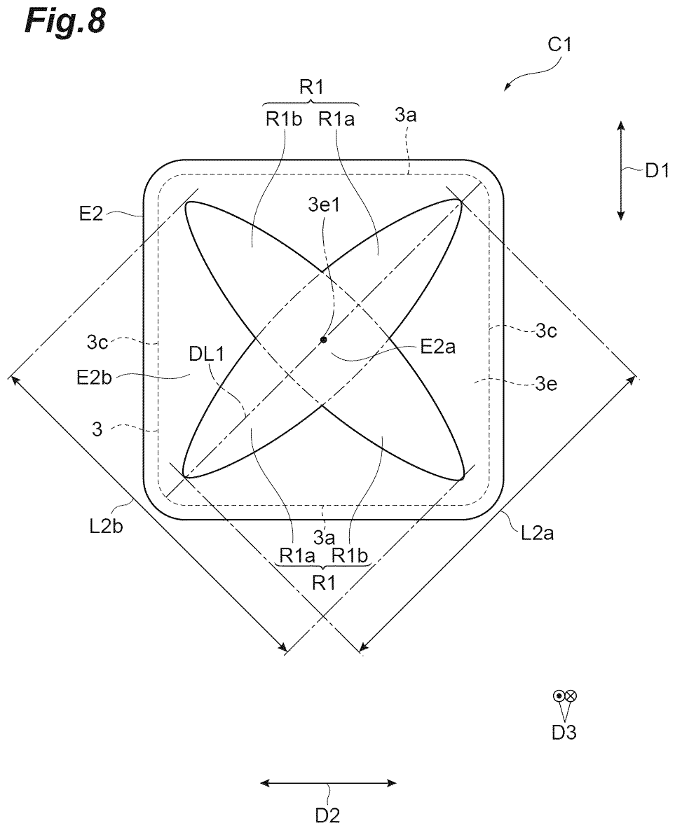

A configuration of a multilayer capacitor C1 according to still another modified example of the first example will be described with reference to FIG. 8. FIG. 8 is a plan view illustrating a second electrode layer. The multilayer capacitor C1 according to this modified example is generally similar to or the same as the multilayer capacitor C1 according to the first example. However, the multilayer capacitor C1 according to this modified example is different from the multilayer capacitor C1 according to the first example in a configuration of the external electrode 5. Hereinafter, differences between the above-described first example and this modified example will be mainly described.

The multilayer capacitor C1 in accordance with this modified example also includes the pair of external electrodes 5.

In the second electrode layer E2, a ridge R1 is formed on the side surface 3e. The ridge R1 is formed along a direction in which the diagonal line DL1 extends and a direction intersecting the direction in which the diagonal line DL1 extends. The ridge R1 includes a ridge R1a and a ridge R1b. The ridge R1a is formed along the direction in which the diagonal line DL1 extends, and the ridge Rib is formed along the direction intersecting the direction in which the diagonal line DL1 extends. For example, the ridge R1 may be formed substantially along the direction in which the diagonal line DL1 extends and the direction intersecting the direction in which the diagonal line DL1 extends. For example, the ridge R1a may be formed substantially along the direction in which the diagonal line DL1 extends, and the ridge R1b may be formed substantially along the direction intersecting the direction in which the diagonal line DL1 extends. For example, the ridge R1a and the ridge R1b intersect with each other at approximately 90°. That is, the ridge R1b is formed along a direction in which another diagonal line extends. When viewed from the direction D3, each of the ridge R1a and the ridge R1b has a substantially oval shape. A longitudinal direction of the substantially oval shape of the ridge R1a includes the direction in which the diagonal line DL1 extends. A longitudinal direction of the substantially oval shape of the ridge R1b includes the direction intersecting the direction in which the diagonal line DL1 extends.

The ridge R1a has a length L2a in the direction in which the diagonal line DL1 extends. The ridge Rib has a length L2b in the direction intersecting the direction in which the diagonal line DL1 extends. Each of the length L2a and L2b is larger than or equal to half of a length L1 of the diagonal DL1 and less than or equal to the length L1 of the diagonal DL1.

### Second Example

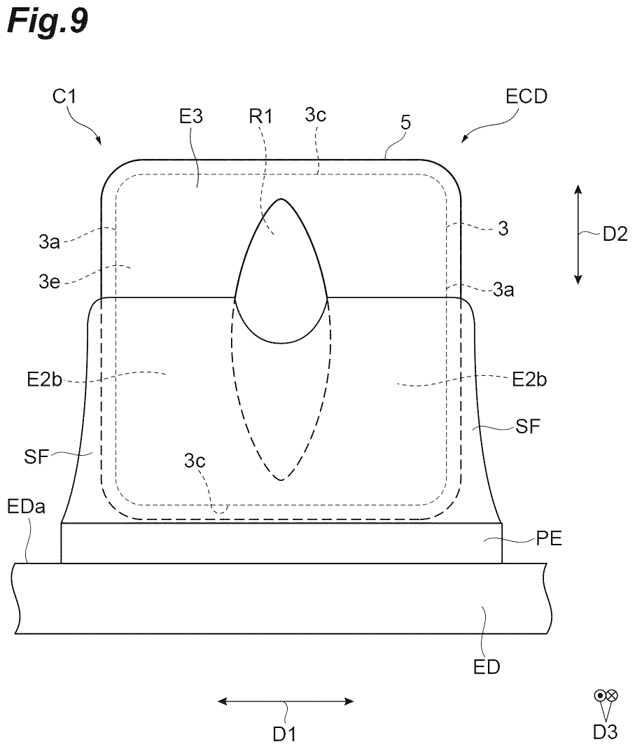

An electronic component device ECD according to the second example will be described with reference to FIG. 9. FIG. 9 is a view illustrating an electronic component device according to a second example.

In the second example, the electronic component device ECD includes the multilayer capacitor C1 according to the first example and an electronic device ED. The multilayer capacitor C1 is mounted on the electronic device ED. For example, the multilayer capacitor C1 is solder-mounted on the electronic device ED. The electronic device ED includes, for example, a circuit board or an electronic component. The electronic device ED includes a main surface EDa. The electronic device ED includes, for example, a pair of pad electrodes PE disposed on the main surface EDa. The pair of pad electrodes PE are electrically connected to the multilayer capacitor C1. Each of the pair of pad electrodes PE is electrically connected to a corresponding external electrode 5 of the pair of external electrodes 5. The pair of pad electrodes PE are separated from each other. The multilayer capacitor C1 is disposed on the electronic device ED in such a manner that the main surface EDa and the main surface 3c oppose each other, for example. That is, for example, the side surface 3c is arranged to constitute a mounting surface. FIG. 9 illustrates only one pad electrode PE of the pair of pad electrodes PE.

In solder-mounting the multilayer capacitor C1, molten solder wets the external electrode 5. The molten solder wets third electrode layer E3 arranged to include an outermost layer of the external electrode 5.

The ridge R1 is formed along the direction D2. The third electrode layer E3 positioned on the ridge R1 includes a region protruding toward the outside of the element body 3 and along the direction D2. The molten solder wet the third electrode layer E3 along a direction in which the ridge R1 is formed, that is, along the direction D2. The molten solder tends to wet the third electrode layer E3 positioned on the region E2b, and tends not to wet the third electrode layer E3 positioned on the ridge R1. A height in the direction D2 at which the molten solder wets the third electrode layer E3 positioned on the region E2b is larger than a height in the direction D2 at which the molten solder wet the third electrode layer E3 positioned on the ridge R1.

The molten solder wets the third electrode layer E3 and then solidifies to form a solder fillet SF. The solder fillet SF is formed on the external electrode 5. The external electrodes 5 and the pad electrodes PE that correspond to each other are coupled to each other via the solder fillet SF. The multilayer capacitor C1 and the electronic device ED are electrically connected to each other.

In the electronic component device ECD, the ridge R1 is formed, for example, along the direction D2. The molten solder wets the third electrode layer E3 along the direction D2. That is, the molten solder tends to wet a region, of the third electrode layer E3, corresponding to the region E2b more than a region, of the third electrode layer E3, corresponding to the ridge R1. Therefore, the multilayer capacitor C1 can be firmly soldered to the electronic device ED.

### Third Example

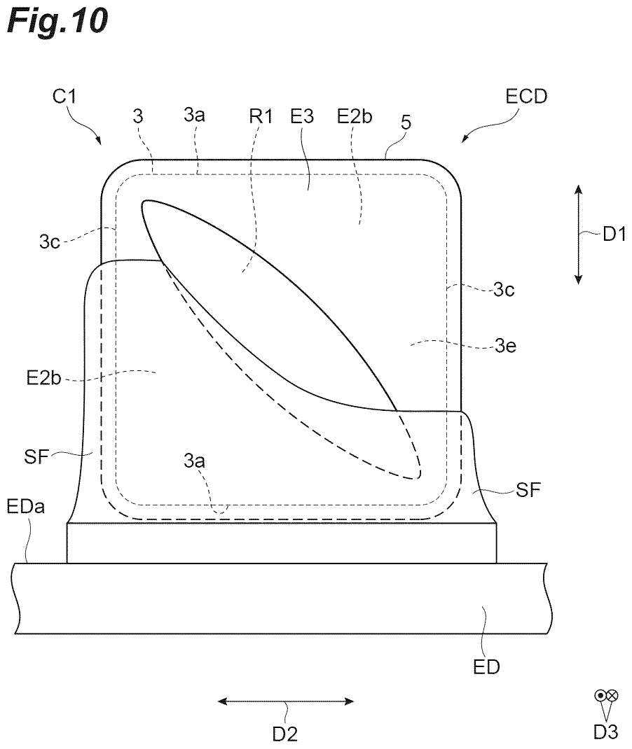

An electronic component device ECD according to the third example will be described with reference to FIG. 10. FIG. 10 is a view illustrating an electronic component device according to a third example.

In the third example, the electronic component device ECD includes the multilayer capacitor C1 according to the modified example illustrated in FIG. 6 and the electronic device ED. The electronic component device ECD according to the third example is different from the electronic component device ECD according to the second example in the multilayer capacitor C1 to be mounted. Hereinafter, differences between the second example and the third example will be mainly described.

The multilayer capacitor C1 is disposed on the electronic device ED in such a manner that the main surface EDa and the main surface 3a oppose each other, for example. The side surface 3a may be arranged to constitute a mounting surface. FIG. 9 illustrates only one pad electrode PE of the pair of pad electrodes PE.

Also in the third example, similarly to the second example, the molten solder tends to wet the third electrode layer E3 positioned on the region E2b, and tents not to wet the third electrode layer E3 positioned on the ridge R1.

In the multilayer capacitor C1 mounted on the electronic device ED, the ridge R1 is positioned to include a first end away from the electronic device ED and a second end close to the electronic device ED. The molten solder tends to wet the third electrode layer E3 to the first end of the ridge R1. The molten solder tends not to wet the third electrode layer E3 beyond the second end of the ridge R1. A height at which the molten solder wets the third electrode layer E3 to a position corresponding to the first end of the ridge R1 is larger than a height at which the molten solder wets the third electrode layer E3 beyond a position corresponding to the second end of the ridge R1.

In the electronic component device ECD, the ridge R1 is formed, for example, along the diagonal line DL1. The molten solder wets the third electrode layer E3 along the diagonal line DL1. That is, the molten solder wets mainly a region, of the third electrode layer E3, corresponding to the region E2b closer to the electronic device ED than the ridge R1. Therefore, the multilayer capacitor C1 can be firmly soldered to the electronic device ED.

It is to be understood that not all aspects, advantages and features described herein may necessarily be achieved by, or included in, any one particular example. Indeed, having described and illustrated various examples herein, it should be apparent that other examples may be modified in arrangement and detail.

When viewed from the direction orthogonal to the side surface 3e, the ridge R1 may not overlap with the center 3e1 of the side surface 3e. As described above, a configuration in which when viewed from the direction orthogonal to the side surface 3e, the ridge R1 overlaps with the center 3e1 of the side surface 3e tends to move the gas generated from the moisture from the position corresponding to the center 3e1 of the side surface 3e toward the position corresponding to the end edge of the side surface 3e. Therefore, the multilayer capacitor C1 can reliably prevent the peel-off of the second electrode layer E2.

The at least one direction described above may not include the direction parallel to the one side of the side surface 3e having the rectangular shape. As described above, a configuration in which the at least one direction described above includes the direction parallel to the one side of the side surface 3e having the rectangular shape tends to move the gas generated from the moisture toward the position corresponding to the end edge of the side surface 3e. Therefore, the multilayer capacitor C1 can reliably prevent the peel-off of the second electrode layer E2.

The at least one direction described above may not include the direction along the diagonal line DL1 of the side surface 3e having the rectangular shape. As described above, a configuration in which the at least one direction described above includes the direction along the diagonal line DL1 of the side surface 3e having the rectangular shape tends to move the gas generated from the moisture toward the position corresponding to the end edge of the side surface 3e. Therefore, the multilayer capacitor C1 can reliably prevent the peel-off of the second electrode layer E2.

For example, the ridge R1 may be formed along a direction intersecting the diagonal line DL1 of the side surface 3e having the rectangular shape, on the side surface 3e.

In the modified examples illustrated in FIGS. 7 and 8, the ridge R1 is formed along two directions intersecting each other. However, the ridge R1 may be formed along three or more directions intersecting each other.

In the modified examples illustrated in FIGS. 7 and 8, the ridge R1 is formed along four directions from the center 3e1 of the side surface 3e when viewed from the direction orthogonal to the side surface 3e. However, the ridge R1 may be formed along three directions or five or more directions from the center 3e1 of the side surface 3e when viewed from the direction orthogonal to the side surface 3e.

In the present examples and modified examples, the electronic component includes the multilayer capacitor. However, applicable electronic component is not limited to the multilayer capacitor. The applicable electronic component includes, for example, a multilayer electronic component such as a multilayer inductor, a multilayer varistor, a multilayer piezoelectric actuator, a multilayer thermistor, a multilayer solid-state battery component, or a multilayer composite component, or electronic components other than the multilayer electronic components.

What is claimed is:

1. An electronic component, comprising:
an element body including a side surface; and
an external electrode disposed on the side surface and including a conductive resin layer, the conductive resin layer is formed with a ridge extending along at least one direction, on the side surface, and includes a region, on the side surface, having a thickness smaller than a thickness at the ridge.

2. The electronic component according to claim 1, wherein
when viewed from a direction orthogonal to the side surface, the ridge overlaps with a center of the side surface.

3. The electronic component according to claim 1, wherein
the side surface has a rectangular shape, and
the at least one direction includes a direction parallel to one side of the side surface having the rectangular shape.

4. The electronic component according to claim 1, wherein
the side surface has a rectangular shape, and
the at least one direction includes a direction along a diagonal of the side surface having the rectangular shape.

5. The electronic component according to claim 1, wherein
the ridge is formed along a plurality of directions including the at least one direction and intersecting each other, on the side surface.

6. The electronic component according to claim 1, wherein
the side surface has a rectangular shape, and
the ridge has a length in the at least one direction that is larger than or equal to half of a length of a diagonal of the side surface having the rectangular shape and smaller than or equal to the length of the diagonal.

7. The electronic component according to claim 1, wherein
the ridge has a shape in which a width in the at least one direction is larger than a width in a direction orthogonal to the at least one direction, in a cross-section obtained by cutting the ridge at a plane parallel to the side surface.

8. The electronic component according to claim 7, wherein
the ridge has an oval shape when viewed from a direction orthogonal to the side surface.

9. The electronic component according to claim 1, wherein
the ridge has a shape in which a region with gradual change in height is larger in a cross-section cut by a plane orthogonal to the side surface and along the at least one direction, as compared with in a cross-section cut by a plane orthogonal to both the side surface and the at least one direction.

10. The electronic component according to claim 1, wherein
the ridge has a shape in which a change in height in a cross-section cut by a plane orthogonal to both the side surface and the at least one direction is steeper than a change in height in a cross-section cut by a plane orthogonal to the side surface and along the at least one direction.
